(19) United States
(12) Patent Application Publication
(10) Pub. No.: US 2008/0190172 A1
(43) Pub. Date: Aug. 14, 2008

(54) Inductively Powered Remote Oxygen Sensor

(75) Inventor: Anthony Patrick Jones, Hertfordshire (GB)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(73) Assignee: GLAXO GROUP LIMITED, Greenford, Middlesex (GB)

(21) Appl. No.: 11/915,745

(22) PCT Filed: May 30, 2006
(86) PCT No.: PCT/US06/20666

§ 371 Date: Nov. 28, 2007

Related U.S. Application Data
(60) Provisional application No. 60/686,594, filed on Jun. 2, 2005.

(51) Int. Cl. G01N 27/00

(52) U.S. Cl. 73/23.2

(57) ABSTRACT

A sensor apparatus for determining oxygen concentration within a sealed package comprises a sensor capable of measuring oxygen concentration; and an inductive power receiver, wherein said sensor is powered by said inductive power receiver and communicates data representing said oxygen concentration wirelessly.

### FIELD OF THE INVENTION

The present invention relates generally to devices and systems for sensing environmental conditions. More particularly, the invention relates to sensor systems and methods for determining and relaying oxygen concentration within sealed pharmaceutical packaging.

### BACKGROUND OF THE INVENTION

Oxidative degradation of pharmaceuticals is well documented and is known to decrease drug potency and reduce product life. Product discoloration, changes in solubility, and precipitation can also result from oxidation. More importantly, oxidative degradation by-products formed during storage can have adverse pharmacological properties. Certain formulations, particularly solid dose forms of pharmaceuticals, are particularly susceptible to oxidative degeneration. Accordingly, monitoring conditions that can lead to oxidation is of critical importance in the distribution of pharmaceuticals.

Similarly important are methods for mitigating the deleterious effects of oxidation. One promising method is the use of modified atmosphere packaging. This technology generally comprises the use of an inert gas to displace oxygen-containing atmosphere within the sealed packaging. Modified atmosphere packaging offers a number of benefits, most notably, increasing the shelf life of any pharmaceutical subject to oxidative degradation. Improved stability has the potential of fostering the development of oral formulations that are otherwise prone to oxidation. For example, modified atmosphere packaging may facilitate the availability of critical therapeutic agents in a high-quality, stable, and convenient dosage form.

Modified atmosphere packaging requires the use of materials that offer low permeability to oxygen and manufacturing processes that facilitate the purging of oxygen contaminated atmosphere. To date, modified atmosphere packaging techniques have not generally been adopted for solid dose pharmaceuticals despite the benefits. One of the factors impeding the use of these advanced methods is the difficulty in designing and evaluating appropriate packaging. Thus, the ability to monitor conditions that lead to oxidative degradation within sealed packaging is necessary to expand the use of modified atmosphere packaging.

Oxidative degradation depends on the environmental conditions within the pharmaceutical packaging. Since oxygen participates in a reaction that leads to the degradation, oxygen concentration is a primary contributor to oxidation. Other environmental conditions, particularly the temperature and relative humidity, also significantly influence the rate of degradation.

In view of these considerations, there is a need for rapidly determining oxygen concentrations within sealed pharmaceutical packaging. Such determinations are necessary to predict the stability, shelf life and potency of sealed pharmaceuticals and to design and evaluate modified atmosphere packaging. A number of prior art methods have been used to evaluate oxygen concentration, including gas chromatography, ion-selective electrodes, spectroscopy, spectrometry and fiber optic fluorescence probes.

Unfortunately, these methods typically require physical penetration of the pharmaceutical packaging. Accordingly, such methods are not particularly desirable as piercing the packaging can allow the interior conditions to be modified, undermining the accuracy of the determination. These methods also can require a larger volume of gas for an accurate sampling to be made than is available in certain forms of packaging. Further, the packaging is destroyed which prevents any ongoing monitoring of the environmental conditions.

To overcome the disadvantages associated with physical penetration of the package, a purely optical determination such as the assessment of fluorescence quenching has been suggested. Although such methods can determine oxygen concentrations within a sealed package, they require the use of materials that are transparent to both the excitation and fluorescence frequencies. Accordingly, these material constraints significantly limit the range of applications open to prior art optical methods.

It is therefore an object of the present invention to provide a highly efficient, cost effective means for determining oxygen concentration within sealed pharmaceutical packaging.

It is another object of the present invention to provide a remote sensor system and method for determining oxygen concentration within pharmaceutical packaging.

It is another object of the present invention to provide a remote sensor system and method that can be externally powered.

It is another object of the present invention to provide a remote sensor system and method that has minimal effect on the environmental condition(s) within the packaging.

It is another object of the present invention to provide a remote sensor system and method that communicates data while maintaining the integrity of the packaging during monitoring, allowing ongoing accurate determination of environmental conditions.

It is yet another object of the present invention to provide a remote oxygen sensor together with remote humidity and remote temperature sensors.

It is another object of the present invention to provide a remote sensor system and method that effectively communicates data through the pharmaceutical packaging.

### SUMMARY OF THE INVENTION

In accordance with the above objects and those that will be mentioned and will become apparent below, the present invention relates to systems and methods for remotely sensing oxygen concentration within sealed pharmaceutical packaging. In one embodiment of the invention, the invention comprises a sensor capable of measuring oxygen concentration and an inductive power receiver, wherein the sensor is powered by the inductive power receiver and communicates data representing the oxygen concentration wirelessly. Preferably, the sensor comprises a fluorescence quenching oxygen sensor. In such embodiments, the sensor can comprise a light emitting diode that generates an excitation wavelength and a fluorescing element.

In one aspect of the invention, the sensor also includes a photodetector. Preferably, the sensor further comprises a wireless transmitter configured to send data corresponding to a signal from the photodetector. Also preferably, the wireless transmitter includes an RF antenna, an inductive coil or an acoustic transducer.

In an alternative aspect, the fluorescing element emits a wavelength that is transmitted directly through the packaging and optically detected with a photodetector. In such embodiments, the packaging is substantially transparent to the emitted wavelength.

In a further aspect of the present invention, the sensor also comprises a controller that is adapted to operate the sensor, the power receiver and the wireless transmitter.

In one presently preferred embodiment of the invention, the sensor comprises an LED, wherein the inductive power receiver generates an AC waveform having a positive half cycle and a negative half cycle, and wherein the LED is driven by the positive half cycle or the negative half cycle.

In another preferred embodiment of the invention, the sensor comprises a first LED and a second LED, wherein the inductive power receiver generates an AC waveform having a positive half cycle and a negative half cycle, and wherein the first LED is driven by the positive half cycle and the second LED is driven by the negative half cycle.

In yet another embodiment, the invention comprises a sensor system for determining oxygen concentration, with a remote sensor apparatus having a sensor capable of measuring oxygen concentration and an inductive power receiver, and an inductive power supply, wherein the inductive power supply is configured to inductively couple with the power receiver and wherein the sensor is powered by the inductive power receiver and communicates data representing oxygen concentration wirelessly. Preferably, the sensor communicates data representing oxygen concentration wirelessly using a transmitter selected from the group consisting of radio frequency, inductive coupling, acoustic and optical. Also preferably, the sensor system has a wireless receiver including a radio frequency antenna, an inductive coil, a microphone or a photodetector.

In one aspect of the invention, the wireless receiver and the inductive power supply are integrated into a handheld reader.

In further embodiments of the invention, the sensor system also includes an inductively powered remote temperature sensor or an inductively powered remote relative humidity sensor, wherein the sensors are configured to communicate data wirelessly. Preferably, the sensor system includes both a temperature sensor and a relative humidity sensor in conjunction with the oxygen sensor.

The invention also comprises methods for determining oxygen concentration within pharmaceutical packaging using the inventive sensor systems. In one embodiment of the invention, the method comprises the steps of sealing the remote sensor inside pharmaceutical packaging, powering the remote sensor by inductively coupling the power supply with the power receiver, measuring the oxygen concentration with the sensor and transmitting data wirelessly. Preferably, the method further includes the step of receiving the transmitted data. Also preferably, the step of transmitting data includes generating radio frequency emissions, generating a magnetic field with an inductive coil, detuning an electrical circuit, generating acoustical sound waves or emitting fluorescent light through said packaging.

In a further aspect of the invention, the method further comprises the steps of sealing inductively powered remote temperature or relative humidity sensors within the packaging, inductively powering the remote temperatures or relative humidity sensors, measuring temperature and relative humidity with the sensors, and transmitting data corresponding to the temperature or relative humidity wirelessly. More preferably, both temperature and relative humidity sensors are employed.

The systems and methods of the invention feature an inductively powered sensor sealed within a package and the wireless transmission of data from the sensor through the packaging. Accordingly, these system and methods do not alter the packaging and allow ongoing monitoring of oxygen concentration within the packaging.

### BRIEF DESCRIPTION OF THE DRAWINGS

Further features and advantages will become apparent from the following and more particular description of the preferred embodiments of the invention, as illustrated in the accompanying drawing, and in which like referenced characters generally refer to the same parts or elements throughout the views, and in which:

FIG. 1 is a schematic view of a sensor system of the invention disposed within a pharmaceutical delivery device;

FIG. 2 is an elevational view of the sensor system shown in FIG. 1, illustrating the components thereof;

FIG. 3 is an elevational view of the primary components of a power supply of the invention;

FIG. 4 is a top plan view of a power transmitter embodying features of the invention;

FIG. 5 is a schematic illustration of a power transmitter embodying features of the invention;

FIG. 6 is a diagram showing the electromagnetic field produced by a power transmitter embodying features of the invention; and

FIG. 7 is a schematic illustration of another embodiment of a sensor system embodying features of the invention.

### DETAILED DESCRIPTION OF THE PREFERRED EMBODIMENT

Before describing the present invention in detail, it is to be understood that this invention is not limited to particularly exemplified systems or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an”, “the” and “one” include plural referents unless the content clearly dictates otherwise. Thus, for example, reference to “a package” includes two or more such packages.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the present invention has the ability to substantially reduce or eliminate the disadvantages and drawbacks associated with conventional sensor systems and methods for determining oxygen concentration within sealed packaging. As indicated, the sensors of the invention are configured to wirelessly receive power to measure oxygen concentration and then wirelessly transmit data through the sealed pharmaceutical packaging. Thus, the inventive sensors and methods allow measurements to be made without interfering with the integrity of the packaging, are small enough to be incorporated within the pharmaceutical packaging, do not rely on batteries that may fail or effect environmental conditions and allow ongoing monitoring of oxygen concentration.

In a preferred embodiment of the invention, an inductive coupling is used to power a fluorescence quenching oxygen sensor and associated electronics inside the pharmaceutical packaging without the need for connecting wires or batteries. The inductive coupling is optimized for the medicament or pharmaceutical composition and packaging characteristics. The sensor is powered inductively and transmits data wirelessly to maintain the packaging integrity and avoid alteration of the packaging. Suitable wireless communication means include acoustic, optical, radio frequency and inductive coupling.

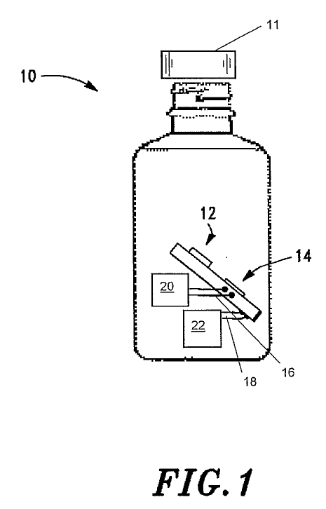

Referring now to FIG. 1, there is shown a pharmaceutical package 10 with lid closure 11 having sensor 12 and controller 14 mounted inside package 10, according to the invention. Wires 16 and 18 provide connection to inductive power receiver 20 and wireless transmitter 22, shown schematically. Any suitable pharmaceutical package can be used. For the purposes of example, a conventional one-inch diameter polyethylene bottle adapted to be foil sealed and employing a screw top, non-child resistant closure is shown. In other applications, depending upon the relative dimensions, the sensor apparatus can be placed primarily within the bottle or within the lid.

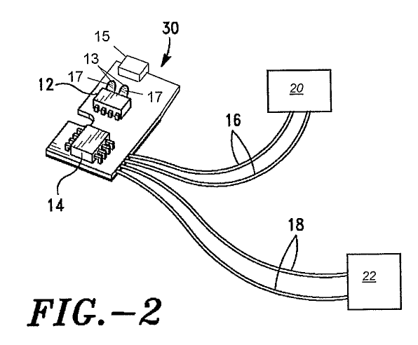

FIG. 2 shows components of the sensor system 30. The system includes a power receiver 20 and wireless transmitter 22, shown schematically, that are connected to printed circuit board (PCB) 30 having sensor 12 and controller 14 disposed thereon. As described above, the sensor system is configured to fit within the package 10 being monitored.

Sensor 12 preferably comprises a fluorescence quenching (FQ) sensor having one or more LEDs 13, photodetector 15, and fluorophore film coating 17. Suitable FQ sensors utilize a light source, such as LED 13, to provide an excitation wavelength near the blue region of the spectrum. In a preferred embodiment, a blue-green LED emitting at approximately 470 nm is used. The fluorescing element, such as film coating 17 on LED 13, utilizes a fluorescent material in which the fluorescence is quenched by oxygen. Preferably, film coating 17 is a ruthenium complex. Also preferably, the fluorescing elements of the present invention radiate light upon excitation by a suitable wavelength, with a maximum emitted wavelength of approximately 600 nm. Photodetector 15 is preferably configured to respond to the emitted wavelength.

The degree of quenching is proportional, and the intensity of emitted light is correspondingly inversely proportional, to the oxygen concentration. Thus, determination of oxygen concentration can be made by several suitable techniques, including fluorescence intensity, fluorescence decay time, change in modulation depth of fluorescence signal when the excitation source is modulated, and measurement of phase shift of luminescence signal relative to the excitation signal.

Luminescence quenching occurs when the quenching molecule interacts with an excited molecule of the fluorophore, causing a nonradiative transfer of energy to the quencher. This lowers the intensity of luminescent emission or shortens the decay time. In preferred embodiments of the invention, the partial pressure of oxygen qualitatively relates to the fluorescence-intensity quenching according to a simplified Stem-Volmer equation:

Iₒ/I=1+KpO₂,

Where Iₒ is the unquenched fluorescence intensity, I is the quenched fluorescence intensity, K is the quenching constant, and pO₂ is the oxygen partial pressure.

As one having skill in the art will appreciate, a more complex version of the Stern-Volmer equation using factorial expansions can be used to determine the oxygen concentration more precisely.

In one embodiment, the FQ sensors of the present invention thus feature a rapid response in the range of approximately 5 sec to 2 min, which corresponds to the time required for oxygen to diffuse to film coating 17. Further, these sensors fulfill the requirements of small size for inclusion within a wide range of sealed pharmaceutical packaging. Also, since the sensors do not consume oxygen in the quenching reaction, they require a low sample volume, approximately 100 μl.

In a preferred embodiment, two LEDs 13 are driven directly by inductive power receiver 20. The sensor is configured so that one emits on the positive half cycle and the other emits on the negative half cycle of an AC drive waveform induced in power receiver 20. Film coating 17 is excited by radiation from LEDs 13, and fluoresces to varying degrees depending upon any quenching reactions driven by oxygen present. Photodetector 15 receives the fluorescent radiation so that the voltage generated by photodetector 15 represent the fluorescence signal and allows determination of oxygen concentration. Alternatively, a single LED can be driven by either the positive or negative half cycle.

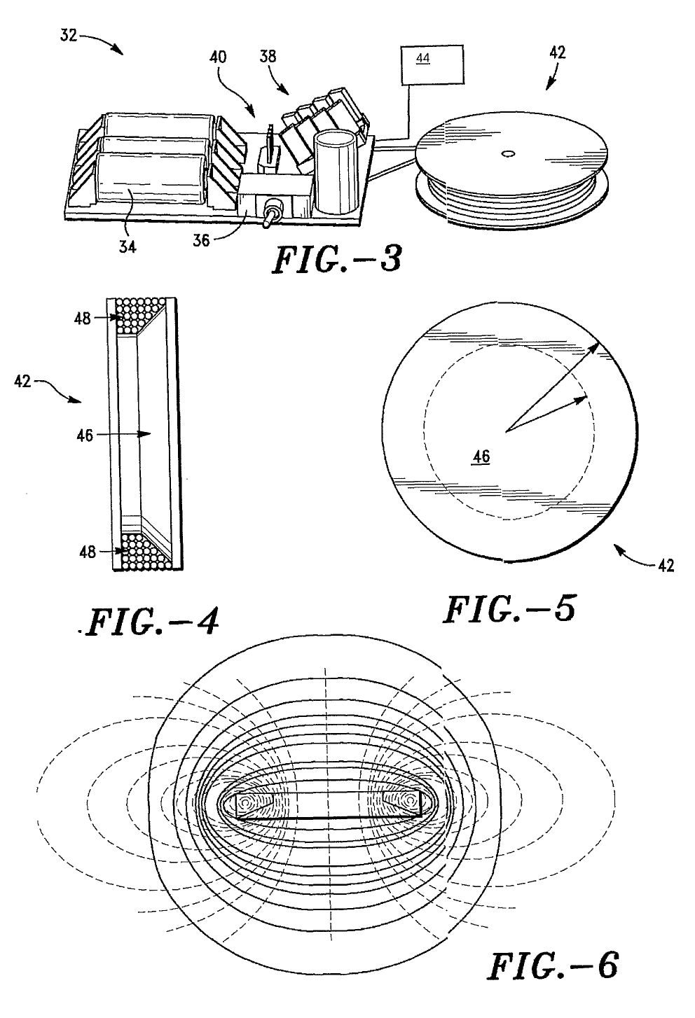

Referring to FIG. 3, power supply 32 generally comprises power source 34, switch 36, signal generator 38, current amplifier 40, power transmitter 42, and wireless receiver 44 (shown schematically).

Inductive power supplies are commonly used to supply power to an electrical circuit without connecting wires. However, power supplies suitable for the practice of the invention often have certain characteristics. Depending upon the embodiment and the type of pharmaceutical packaging, separation between power receiver 20 and power transmitter 42 can be up to approximately 12 mm, or more.

The power supply is preferably robust enough to transmit across this distance and through the pharmaceutical packaging material, which may be metallic. Further, the power supply is preferably efficient, as too much heat generation will affect the sensor readings. Preferably, the power supply should allow at least 5 readings to be made sequentially without raising the temperature of the sensor by more than about 1° C.

The power supply should also be useful in mobile applications and preferably incorporate a handheld reader device. Such a device provides power to the sensor, receives and decodes the data, and either stores the data or relays the data back to a computer. As described below, wireless receiver 44 is adapted to cooperate with wireless transmitter 22, for embodiments using RF, acoustic or inductive coupling telemetry. Alternatively, wireless receiver 44 comprises a photodetector in embodiments where emitted fluorescence is measured directly through packaging 10.

Finally, power transmitter 42 should be configured to allow easy coupling with power receiver 20 within the pharmaceutical packaging. For example, the induced magnetic field should be approximately even in 20 mm diameter circles parallel to the face of transmitter 42 to allow easy location of packaging 10 relative to the transmitter. Accordingly, a preferred embodiment of the power supply is a low voltage, battery powered wireless and mobile device. Preferably, power transmitter 42 should induce a suitable voltage in inductive power receiver 20, through packaging 10, at a distance of approximately 15 mm, and more preferably, approximately 20 mm.

Power supply 32 generally has three separate functions. The functions include power transmission, current amplification and signal generation.

Referring now to FIGS. 4 and 5, power transmitter 42 comprises lightweight plastic former 46 and coil 48, wound using approximately 30 turns of tightly-wound, approximately 1.12 mm diameter, enameled covered copper wire. As illustrated in FIG. 4, coil 48 is preferably formed over a constant diameter portion of about 2.5 mm thickness and a tapered portion of about 5 mm thickness of plastic former 46. In the top view, shown in FIG. 5, the tapered portion of former 46 ranges from a radius of about 15 mm to about 25 mm.

It has been found that using relatively thick wire and a low number of turns minimizes the resistance of the coil. In this embodiment resistance is preferably approximately 80 mΩ. As will be appreciated by one having ordinary skill in the art, inductance depends on coil geometry, wire geometry and materials used.

The use of a non-conductive, non-magnetic plastic former rather than, for example, an iron core is a major factor in keeping the inductance down. The use of a relatively large diameter also has this effect to some extent while keeping the field relatively even.

In this embodiment, a relatively low number of turns results in an inductance of approximately 53 μH. Increasing the current flowing through the inductor increases the strength of the magnetic field, but as long as the resistance is low, power wastage can be minimized despite the large currents involved.

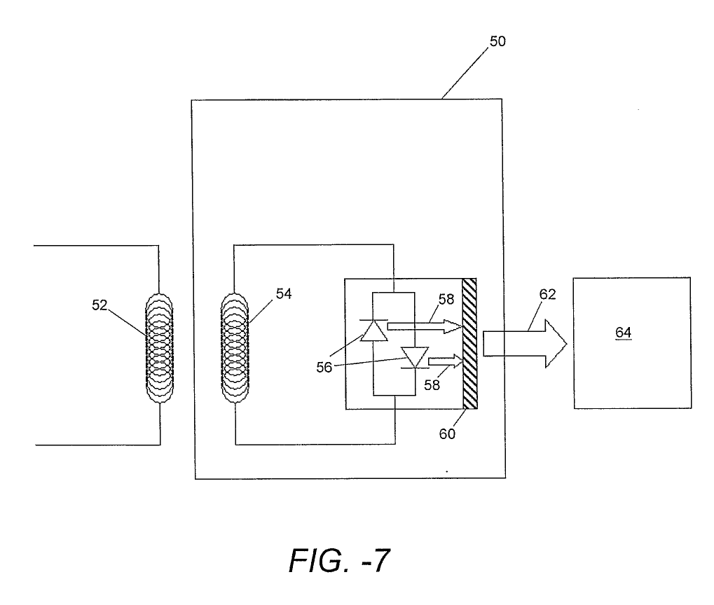

Referring now to FIG. 6, there is shown a diagram of the preferred magnetic field generated by power transmitter 42. From the areas showing strong magnetic field in the diagram, one having skill in the art will appreciate that at an operating distance of approximately 10 mm from the coil, the field is even over a 30 mm diameter circle and at a distance of 15 mm from the coil, the field is even over a 20 mm diameter circle. This permits an easy interface with power receiver 20 of device 10. The diagram also illustrates that the magnetic field is stronger above the power transmitter than below it and is very even. This indicates that the power transfer efficiency is very high.

In one embodiment of the present invention, wireless transmitter 22 comprises an antenna and communicates data from sensor 12 via radio frequency. Depending upon the application, a signal from photodetector 15 can be processed by sensor 12 and the results transmitted through the antenna. Alternatively, the raw signal from photodetector 15 can be directly passed to wireless transmitter 22, which can subsequently be received and processed, external to packaging 10.

In another embodiment of the present invention, wireless transmitter 22 comprises a coil and uses inductive coupling to communicate data from sensor 12. Photodetector 15 generates a voltage in response to the fluorescence signal, which is then used to drive the coil in wireless transmitter 22. A voltage signal is correspondingly induced in a receiving coil, which is used to determine the oxygen concentration. Alternatively, the response of photodetector 15 can detune or otherwise interfere with the operation of a tuned circuit in a manner that is detectable outside the sealed packaging.

In yet another embodiment, communication of data collected from sensor 12 is accomplished by wireless transmitter 22 using acoustic telemetry. As is well known, audio encoded telemetry is commonly used in telecommunications, e.g., MODEMs for computer communications. Accordingly, when used with pharmaceutical packaging, this invention can employ acoustic transmission to overcome the electrical shielding characteristics. Indeed, sound waves are relatively unaffected by the pharmaceutical packaging, and thus can provide a significant advantage over radio frequency transmission in these applications.

In certain embodiments of the invention, audio waves below about 2 kHz are the preferred means of transmitting data from sensor 12. More preferably, the data is sent using the conventional RTTY protocol, although any type of audio telemetry is suitable. As is well known, RTTY utilizes Frequency-Shift-Keying (FSK), allowing for easy detection of the signal over random noise.

In embodiments where acoustic data is processed by a personal computer, existing telemetry or telecommunications software methods can be adapted to interpret the signal. Alternatively, a handheld reader can be employed that includes power supply 32 and a wireless receiver 44 comprising a microphone that feeds input into a data controller programmed to interpret the encoded data and then display, store or relay that data.

In one embodiment, Baudot code can be used and the data transmitted twice at 150 baud for every measurement taken from the sensor. An example format suitable in the practice of the invention is shown in Table I, which shows a transmission protocol for relaying data corresponding to oxygen concentration, temperature and relative humidity. High frequency is approximately 1300 Hz and low frequency is approximately 1130 Hz.

TABLE I
Data Transmission Format

Signal to stabilize receiver
Carriage Return
S
5 figure serial number in decimal
Space
O
Oxygen concentration in form x.xxx
Space
H
Humidity in form xx.xx
Space
T
Temperature in form −xx.xx if negative or xxx.xx if positive
3 spaces
S
5 figure serial number in decimal
Space
O
Oxygen concentration in form x.xxx
Space
H
Humidity in form xx.xx
Space
T
Temperature in form −xx.xx if negative or xxx.xx if positive
3 spaces

Alternatively, certain embodiments of the present invention do not require a wireless transmitter. In one such embodiment, shown schematically in FIG. 7, package 50 is substantially transparent to the fluorescence wavelength. Inductive power transmitter 52 couples with inductive power receiver 54, which in turn drives LEDs 56 to emit light 58 at the excitation wavelength. Fluorophore coating 60 emits light 62 at the fluorescent wavelength, which is transmitted through packaging 50 and detected by wireless receiver 64, comprising a photodetector. By detecting the signal outside the sealed package, the number of electronic components required to be included within the packaging is minimized. Although these embodiments require the use of packaging materials that are substantially transparent light 62 having the fluorescent wavelength, the inductively powered LEDs 56 are contained within the sealed package 50 and do not require packaging materials transparent to light 58 having the shorter excitation wavelength. As one having skill in the art will appreciate, a wider range of materials are adequately transparent at the longer emitted wavelengths.

In yet another embodiment of the invention, the remote oxygen sensors of the present invention are used in conjunction with remote environmental sensors. In particular, it is desirable to use temperature and relative humidity sensors with the oxygen sensor, because temperature and humidity are important cofactors in determining the rate of oxidative degradation. Temperature monitoring is also important because the fluorescence quenching reaction is a temperature dependent process. Suitable remote environmental sensors are disclosed in co-pending patent application Ser. No. 60/627,562, filed Nov. 12, 2004, which is hereby incorporated by reference in its entirety. The referenced patent application deals primarily with sensors that communicate data wirelessly using an acoustic transducer. Other sensor technologies are also suitable in the practice of the present invention, including those that transmit data wirelessly by radio frequency, inductively, optically or other means that preserve the integrity of the packaging.

The remote oxygen sensor of the present invention, together with other suitable environmental sensors, and the associated electronics are preferably powered using the inductive power supply. The sensors are also preferably interfaced to an embedded controller which encodes the measurements from the sensors in a form suitable for transmission by radio frequency, optical, inductance, audio telemetry, or other suitable means.

Induction, telemetry and remote query techniques may be used in any combination in order to log information from oxygen, relative humidity and temperature sensors within the packaging over a period of time, for example during stability testing. Although the above combination is particularly advantageous, other sensors may also be incorporated.

As one having skill in the art will recognize, the sensor systems and methods of the invention work with unmodified packaging, are small enough to be fitted in pharmaceutical packaging, do not require internal batteries, and communicate ongoing data regarding environmental conditions through pharmaceutical packaging. Indeed, since the sensor system is powered inductively, accurate determination of environmental conditions within the pharmaceutical packaging can be made indefinitely. This allows one to determine the effectiveness of the pharmaceutical packaging and make accurate estimations of drug potency over any given period of time, such as days, weeks, months or years. Further, the environmental conditions, including oxygen concentration, can be monitored at any point over that period of time.

Without departing from the spirit and scope of this invention, one of ordinary skill can make various changes and modifications to the invention to adapt it to various usages and conditions. In particular, the invention has been described primarily in reference to the determination of oxygen concentration within pharmaceutical packaging. However, the invention may be applied to remotely determine oxygen concentration within any package, container or other enclosed space. As such, these changes and modifications are properly, equitably, and intended to be, within the full range of equivalence of the following claims.

1. A sensor apparatus for determining oxygen concentration within a sealed package, comprising:
a sensor capable of measuring oxygen concentration; and
an inductive power receiver,
wherein said sensor is powered by said inductive power receiver and communicates data representing said oxygen concentration wirelessly.

2. The sensor apparatus of claim 1, wherein said sensor comprises a fluorescence quenching oxygen sensor.

3. The sensor apparatus of claim 1, wherein said sensor comprises an LED that generates an excitation wavelength and a fluorescing element.

4. The sensor apparatus of claim 1, wherein said sensor further comprises a photodetector.

5. The sensor apparatus of claim 4, further comprising a wireless transmitter configured to send data corresponding to a signal from said photodetector.

6. The sensor apparatus of claim 5, wherein said wireless transmitter comprises an RF antenna.

7. The sensor apparatus of claim 5, wherein said wireless transmitter comprises an inductive coil.

8. The sensor apparatus of claim 5, wherein said wireless transmitter comprises an acoustic transducer.

9. The sensor apparatus of claim 3, wherein said inductive power receiver generates an AC waveform having a positive half cycle and a negative half cycle, and wherein said LED is driven by said positive half cycle or said negative half cycle.

10. The sensor apparatus of claim 2, wherein said sensor comprises a first LED and a second LED, wherein said inductive power receiver generates an AC waveform having a positive half cycle and a negative half cycle, and wherein said first LED is driven by said positive half cycle and said second LED is driven by said negative half cycle.

11. The sensor apparatus of claim 3, wherein said fluorescing element emits light having a first wavelength when excited and wherein said packaging is substantially transparent to said first wavelength.

12. The sensor apparatus of claim 5, further comprising a controller that is adapted to operate said sensor, said power receiver and said wireless transmitter.

13. A sensor system for determining oxygen concentration, comprising
a remote sensor apparatus having a sensor capable of measuring oxygen concentration and an inductive power receiver; and
an inductive power supply,
wherein said inductive power supply is configured to inductively couple with said power receiver and wherein said sensor is powered by said inductive power receiver and communicates data representing oxygen concentration wirelessly.

14. The sensor system of claim 13, wherein said sensor communicates data representing oxygen concentration wirelessly using a transmitter selected from the group consisting of radio frequency, inductive coupling, acoustic and optical.

15. The sensor system of claim 14, further comprising a wireless receiver adapted to receive said communicated data.

16. The sensor system of claim 15, wherein said sensor communicates data with a radio frequency transmitter and wherein said wireless receiver comprises a radio frequency antenna adapted to receive said communicated data.

17. The sensor system of claim 15, wherein said sensor communicates data with an inductive coil and wherein said wireless receiver comprises an inductive coil adapted to receive said communicated data.

18. The sensor system of claim 15, wherein said sensor communicates data with an acoustic transducer and wherein said wireless receiver comprises a microphone adapted to receive said communicated data.

19. The sensor system of claim 15, wherein said sensor communicates data optically and wherein said wireless receiver comprises a photodetector adapted to receive said communicated data.

20. The sensor system of claim 15, wherein said wireless receiver and said inductive power supply are integrated into a handheld reader.

21. The sensor system of claim 13, further comprising an inductively powered remote temperature sensor, wherein said temperature sensor is configured to communicate data wirelessly.

22. The sensor system of claim 13, further comprising an inductively powered remote relative humidity sensor, wherein said relative humidity sensor is configured to communicate data wirelessly.

23. The sensor system of claim 21, further comprising an inductively powered remote relative humidity sensor, wherein said relative humidity sensor is configured to communicate data wirelessly.

24. A method for determining oxygen concentration within pharmaceutical packaging, said method comprising the steps of:
sealing a remote sensor apparatus inside said pharmaceutical packaging, said remote sensor apparatus having a sensor capable of measuring oxygen concentration and an inductive power receiver;
inductively powering said remote sensor apparatus;
measuring oxygen concentration with said sensor; and
transmitting data corresponding to said oxygen concentration wirelessly.

25. The method of claim 24, further comprising the step of receiving said transmitted data.

26. The method of claim 25, wherein said step of transmitting data comprises generating radio frequency emissions.

27. The method of claim 25, wherein said step of transmitting data comprises generating a magnetic field with an inductive coil.

28. The method of claim 25, wherein said step of transmitting data comprises detuning an electrical circuit.

29. The method of claim 25, wherein said step of transmitting data comprises generating acoustical sound waves.

30. The method of claim 25, wherein said step of transmitting data comprises emitting fluorescent light through said packaging.

31. The method of claim 24, further comprising the steps of:
sealing inductively powered remote temperature and relative humidity sensors within said packaging;
inductively powering said remote temperatures and relative humidity sensors;
measuring temperature and relative humidity with said sensors; and
transmitting data corresponding to said temperature and relative humidity wirelessly.

32. The method of claim 24, wherein the steps do not alter said pharmaceutical packaging.

33. The method of claim 24, wherein the steps of measuring and transmitting occur a plurality of times over a given time period.
